(19) United States
(12) Patent Application Publication
(10) Pub. No.: US 2013/0251449 A1
(43) Pub. Date: Sep. 26, 2013

(54) POSITIVE COUPLING BETWEEN PARTS OF A HOUSING

(71) Applicant: ZF FRIEDRICHSHAFEN AG, Friedrichshafen (DE)

(72) Inventor: Karl-Fritz HEINZELMANN, Meckenbeuren (DE)

(73) Assignee: ZF FRIEDRICHSHAFEN AG, Friedrichshafen (DE)

(21) Appl. No.: 13/798,299

(22) Filed: Mar. 13, 2013

(30) Foreign Application Priority Data
Mar. 22, 2012 (DE) 10 2012 204 626.7

(51) Int. Cl. F16B 5/07

(52) U.S. Cl. CPC F16B 5/07
USPC 403/335

(57) ABSTRACT

A positive coupling between a first housing component (11, 21, 31, 41, 51), which has a first flange (11a, 12a, 31a), and a second housing component (12, 22, 32, 42, 52), which has a second flange (12a, 22a, 32a). The positive coupling is formed by an interlocking element is an insert (13, 23, 33, 43, 53) which is located between the first and the second flanges (11a, 12a; 21a, 22a; 31a, 32a). The recesses (11b, 12b; 21b, 22b; 31b, 32b, 32c; 41b, 42b; 51a) are formed both in the first flange and in the second flange (11a, 21a, 31a, 12a, 22a, 32a) while the projections (13a, 13b; 23a, 23b; 33a to 33d; 43a,43b; 53a) are arranged on both sides of the insert (13, 23, 33, 43, 53) for mating engagement with the recesses (11b, 12b; 21b, 22b; 31b, 32b, 32c; 41b, 42b; 51a).

This application claims priority from German patent application serial no. 10 2012 204 626.7 filed Mar. 22, 2012.

### FIELD OF THE INVENTION

The invention concerns a positive coupling between a first housing component with a first flange and a second housing component with a second flange, wherein interlocking elements in the form of projections and recesses are provided for the transmission of transverse forces between the housing components.

### BACKGROUND OF THE INVENTION

In the older application by the present applicant with official file number DE 10 2011 003 324.6 a positive coupling between a transmission housing and an engine flywheel housing is described. The interlocking elements are in the form, on the one hand, of projections arranged and made integrally with the flange of the transmission housing, and, on the other hand, recesses made in the flange of the engine flywheel housing. The flanges of the two housings are, as it were, keyed into one another so that torque can be transmitted from one housing to the other. The production of such projections and recesses on the housings incurs additional costs.

### SUMMARY OF THE INVENTION

Starting from that prior art, the objective of the present invention is a positive coupling for the better transmission of torques and transverse forces, which can be produced simply and inexpensively.

Accordingly, for the interlocked joint of the type mentioned at the start a separate insert is provided, which can be clamped between the flanges and has projections on both sides, which engage with interlock in recesses arranged in the two flanges. The insert thus acts as a torque or transverse force transmitting element between the two housing components. Compared with the prior art the advantage of the insert provided with projections is that it can be produced inexpensively and can also be fitted simply, for example like a sealing element between the flanges.

According to a preferred embodiment the projections are made integrally with the insert. This keeps production costs low and facilitates assembly.

In a further preferred embodiment the insert can be made from a metallic material. This enables various possibilities for producing the projections, in particular by stamping, punching, collar raising, embossing or solid deformation. Thus, the projections can be made inexpensively from a sheet section in a single working operation.

In a further preferred embodiment the projections can be in the form of collars, i.e. raised perforations which engage with interlock in correspondingly shaped recesses.

According to another preferred embodiment the projections can be in the form of closed protuberances, for example knobs or studs, which are also arranged on both sides of the insert and positively engage in correspondingly shaped recesses in the flanges.

In a further preferred embodiment the projections can be solid, for example cylindrical projections standing out from both sides of the insert, which engage in the recesses.

In another preferred embodiment the insert can be a plastic component. It is then preferably produced by injection molding, the projections being injected with the insert.

According to a further preferred embodiment the projections can be welded onto the insert. In this way tooling costs can be saved.

In another preferred embodiment sealing means are provided between the insert and at least one flange. This produces a sealed joint between the two housing components in the area of the flange plane.

According to a further preferred embodiment the sealing means are in the form of an elastomeric layer which is vulcanized onto the insert, in particular in the area of the projections or studs. This allows the insert and the seal to be fitted as one component.

### BRIEF DESCRIPTION OF THE DRAWINGS

Example embodiments of the invention are illustrated in the drawing and are described in more detail below, so that further characteristics and/or advantages can emerge from the description and/or the drawings, which show:

FIG. 1: known transmission housing having a number of flange planes,

FIG. 2: A first example embodiment of the invention, with an insert between the two housing flanges,

FIG. 3: A second embodiment of the invention for an insert,

FIG. 4: A third embodiment of the invention for an insert,

FIG. 5: A fourth embodiment of the invention for an insert,

FIG. 6: A fifth embodiment of the invention for an insert,

FIG. 7: A section through the insert shown in FIG. 6, with its seal.

### DETAILED DESCRIPTION OF THE PREFERRED EMBODIMENTS

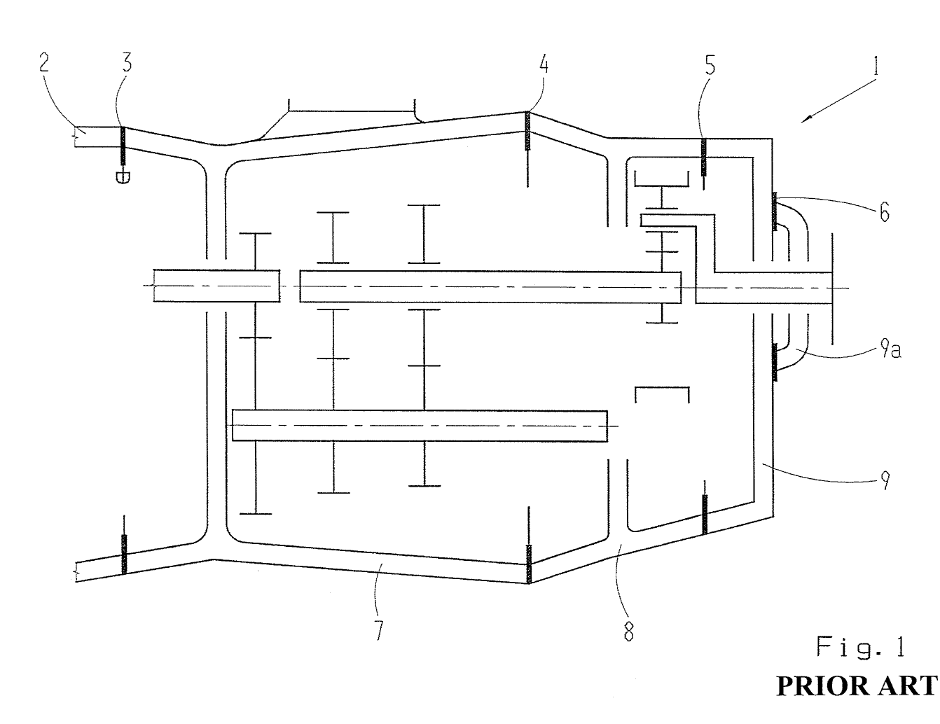

FIG. 1 shows a known transmission housing 1, which is connected by means of a flange 3 to a flywheel housing 2. The transmission housing 1 is divided by further flanges 4, 5, 6 into individual housing components or sections 7, 8, 9, 9a. By means of the flange joints, on the one hand, the housing components are sealed and, on the other hand, the flange joints enable transverse forces and/or torques to be transmitted from one part of the housing to another. In this connection, with a view to more precise details reference is made to the previously mentioned, older application by the present applicant with official file number DE 10 2011 003 324.6, whose entire content is subsumed in the disclosure content of the present application.

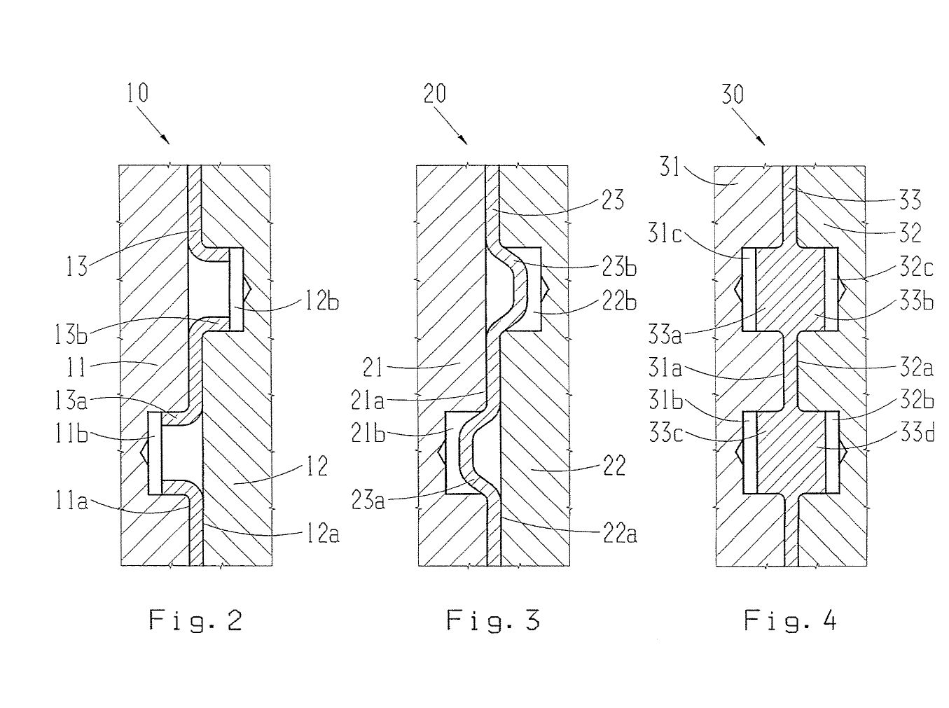

FIG. 2 shows a first example embodiment of the invention for a flange joint 10, which comprises a first housing component 11 having a first flange 11a and a second housing component 12 having a second flange 12a. The flanges 11a, 12a are flat and have depressions or recesses 11b, 12b distributed around the periphery of the flanges 11a, 12a. In this example embodiment the recesses 11b, 12b are in the form of blind bores, i.e. of circular-cylindrical shape. Between the flanges 11a, 12a is arranged a separate insert 13, which has projections 13a, 13b in the form of raised collars or perforations on both sides, i.e. on the side facing the first flange 11a and on the side facing the second flange 12a. In this case the insert 13 is a sheet-metal component, i.e. made from a metallic material; the collars 13a, 13b are produced by punching and drawing through, and are therefore formed integrally with the insert 13. The collars 13a, 13b positively engage, without play, in the recesses 11b, 12b and thus form an interlocked joint between the first housing component 11 and the second housing component 12, so that transverse forces and/or torques can be transmitted. Thus, the insert 13 acts as an interlocking transmission element between the housing components 11, 12.

FIG. 3 shows a second example embodiment of the invention for a flange joint 20 between a first housing component 21 having a first flange 21a and a recess 21b, and a second housing component 22 having a second flange 22a and a recess 22b. Between the two flanges 21a, 22a is clamped a separate insert 23 which has on both sides projections in the form of protuberances 23a, 23b that engage, with interlock, in the recesses 21b, 22b. In contrast to the open perforations 13a, 13b in the first example embodiment, the protuberances 23a, 23b are closed, so that including its projections the insert 23 has an unbroken surface. By virtue of the protuberances 23a, 23b the insert transfers transverse forces and/or torques from the first housing component 21 to the second housing component 22 and thus—as in the first example embodiment—it acts as a transmission element.

FIG. 4 shows a third example embodiment of the invention for a flange joint 30, which connects a first housing component 31 having a first flange 31a and a second housing component 32 having a second flange 32a. In the first flange 31a are formed cylindrical recesses 31b, 31c in the form of blind bores, and in the second flange 32a corresponding recesses 32b, 32c are formed, which are aligned coaxially with the bores 31b, 32c in the first flange 31a. Between the two flanges 31a, 32a is clamped a separate insert 33, which has on both sides projections 33a, 33b and 33c, 33d respectively opposite one another. The insert 33 consists of a metallic material and the projections 33a to 33d are produced by solid deformation such that on both sides of the insert the material is thickened to form cylindrical studs. The solid projections 33a to 33d engage, with interlock and without play, in the recesses 31b 31c on one side and in the recesses 32b, 32c on the other side. As in the previous example embodiments, the insert 33 acts as a transmission element between the two housing components 31, 32.

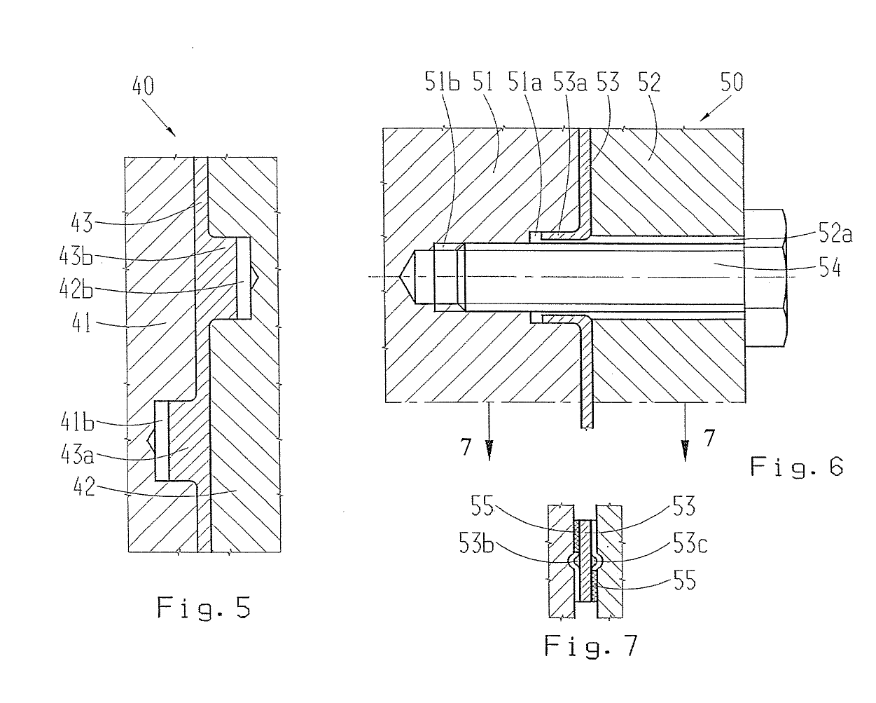

FIG. 5 shows a variant of the example embodiment in FIG. 4, i.e. a fourth example embodiment of the invention for a flange joint 40 between a first housing component 41 and a second housing component 42, in which recesses 41b and 42b are formed. An insert has, in alternation, projections or raised areas 43a on one side and projections or raised areas 43b on the other side, which engage respectively, with interlock and without play, in the recesses 41b of the first housing component 41 and in the recesses 42b of the second housing component 42. Like the insert 33 in FIG. 4, the insert 43 is produced by solid deformation so that solid cylindrical studs 43a, 43b are obtained.

FIG. 6 shows a fifth example embodiment of the invention for a flange joint 50 between a first housing component 51 and a second housing component 52, between which a separate insert 53 is clamped. The first housing component 51 has a recess in the form of a bore 51a leading into a threaded bore 51b which is a threaded blind bore. The insert 53 has a projection 53a in the form of a raised collar or perforation, which engages with interlock in the bore 51a. The second housing component 52 has a through-going bore 52a aligned coaxially with the threaded bore 51b and the raised collar 53a, through which a screw-bolt 54 passes. By virtue of the screw-bolt 54, of which a plurality can be distributed around the circumference of the two housing components, the two housing components are clamped and held together by friction force. In this example embodiment the raised collar or perforation 53a of the insert 53 has a dual function: on the one hand it acts as an interlock element between the two housing components 51, 52 (additional projections as in the previous example embodiments can in this case be omitted), and on the other hand the perforation 53a provides a through-passage for the screw-bolt 54.

FIG. 7 shows a section along the plane 7-7 in FIG. 6. The insert 53 is coated on both sides with a sealant 55, which can be vulcanized to form an elastomer layer on both sides of the insert 53. To improve the sealing action the insert 53 has bumps or bead-like elevations 53b, 53c on both sides. Thus, between the housing components 51, 52 there in formed a joint which is both interlocked and sealed.

### INDEXES

1 Transmission housing
2 Engine flywheel housing
3 Flange
4 Flange
5 Flange
7 Housing section
8 Housing section
9 Housing section
9a Housing section
10 Flange joint
11 First housing component
11a First flange
11b Recess
12 Second housing component
12a Second flange
12b Recess
13 Insert
13a Projection (collar)
13b Projection (collar)
20 Flange joint
21 First housing component
21a First flange
21b Recess
22 Second housing component
22a Second flange
22b Recess
23 Insert
23a Projection (protuberance)
23b Projection (protuberance)
30 Flange joint
31 First housing component
31a First flange
31b Recess
31c Recess
32 Second housing component
32a Second flange
32b Recess
32c Recess
33 Insert
33a Projection (stud)
33b Projection (stud)
33c Projection (stud)
33d Projection (stud)
40 Flange joint
41 First housing component
41b Recess
42 Second housing component
42b Recess
43 Insert
43a Projection (stud)
43b Projection (stud)
50 Flange joint
51 First housing component
51a Recess
51b Threaded bore
52 Second housing component
52a Through-going bore
53 Insert
53a Projection (collar)
53b Elevation
53c Elevation
54 Screw-bolt
55 Sealant

1-11. (canceled)

12. A positive coupling between a first housing component (11, 21, 31, 41, 51) having a first flange (11a, 12a, 31a) and a second housing component (12, 22, 32, 42, 52) having a second flange (12a, 22a, 32a), and the positive coupling being formed by an interlocking element in the form of projections and recesses,
wherein an insert (13, 23, 33, 43, 53) is clamped between the first and the second flanges (11a, 12a; 21a, 22a; 31a, 32a), and
the recesses (11b, 12b; 21b, 22b; 31b, 32b, 32c; 41b, 42b; 51a) are formed both in the first flange and in the second flange (11a, 21a, 31a, 12a, 22a, 32a) and the projections (13a, 13b; 23a, 23b; 33a to 33d; 43a, 43b; 53a) are arranged on both sides of the insert (13, 23, 33, 43, 53).

13. The coupling according to claim 12, wherein the projections (13a, 13b; 23a, 23b; 33a to 33d; 43a, 43b; 53a) are made integrally with the insert (13, 23, 33, 43, 53).

14. The coupling according to claim 12, wherein the insert (13, 23, 33, 43, 53) is made from a metallic material.

15. The coupling according to claim 13, wherein the projections (13a, 13b; 23a, 23b; 33a to 33d; 43a, 43b; 53a) are produced by deformation of the insert (13, 23, 33, 43, 53).

16. The coupling according to claim 12, wherein the projections are raised collars (13a, 13b; 53a) which positively couple in the recesses (11b, 12b, 51a) of the first flange (11a) and of the second flange (12a).

17. The coupling according to claim 12, wherein the projections are closed protuberances (23a, 23b).

18. The coupling according to claim 12, wherein the projections are solid studs (33a to 33d; 43a, 43b).

19. The coupling according to claim 12, wherein the insert (13, 23, 33, 43, 53) is a plastic component.

20. The coupling according to claim 12, wherein the projections (13a, 13b; 23a, 23b; 33a to 33d; 43a, 43b; 53a) are welded onto the insert (13, 23, 33, 43, 53).

21. The coupling according to claim 12, wherein sealing means (55) are arranged between the insert (53) and at least one of the flanges or the housing components (51, 52).

22. The coupling according to claim 21, wherein the sealing means (55) is vulcanized as an elastomeric layer onto the insert (53).

23. A positive coupling comprising:
a first housing component comprising a flange having at least one of a recess,
a second housing component comprising a flange having at least one of a recess,
an insert comprising at least first and second projections, the first and the second projections extending from opposite faces of the insert away from one another,
the first and the second housing components being coupled with the insert arranged therebetween such that the first projection being received within the recess of the first housing component and the second projection being received within the recess of the second housing component.

24. A positive coupling comprising:
a first housing component comprising a flange having a plurality of recesses,
a second housing component comprising a flange having a plurality of recesses,
an insert comprising a plurality of first projections and a plurality of second projections, the plurality of first projections and the plurality of second projections extending from opposite faces of the insert away from one another,
the first and the second housing components being coupled to one another with the insert arranged therebetween such that a respective one of the plurality of first projections being received within each one of the plurality of recesses of the first housing component and a respective one of the plurality of second projections being received within each one of the plurality of recesses of the second housing component.
